(19) United States
(12) Patent Application Publication
(10) Pub. No.: US 2013/0065134 A1
(43) Pub. Date: Mar. 14, 2013

(54) NONAQUEOUS-ELECTROLYTE BATTERY AND METHOD FOR PRODUCING THE SAME

(71) Applicants: Mitsuyasu Ogawa, Itami-shi (JP); Kentaro Yoshida, Itami-shi (JP); Nobuhiro Ota, Itami-shi (JP); Kazuhiro Goto, Itami-shi (JP)

(72) Inventors: Mitsuyasu Ogawa, Itami-shi (JP); Kentaro Yoshida, Itami-shi (JP); Nobuhiro Ota, Itami-shi (JP); Kazuhiro Goto, Itami-shi (JP)

(73) Assignee: Sumitomo Electric Industries, Ltd., Osaka-shi, OSAKA (JP)

(21) Appl. No.: 13/698,125

(22) PCT Filed: May 17, 2011
(86) PCT No.: PCT/JP2011/061277

§ 371 Date: Nov. 15, 2012

(30) Foreign Application Priority Data
May 25, 2010 (JP) 2010-119735
Jan. 5, 2011 (JP) 2011-000492

(51) Int. Cl. H01M 10/0562; H01M 10/02

(52) U.S. Cl. 429/304; 29/623.3

(57) ABSTRACT

Provided are a Li-ion battery (nonaqueous-electrolyte battery) 100 that includes a positive-electrode active-material layer 12, a negative-electrode active-material layer 22, and a sulfide-solid-electrolyte layer 40 disposed between the active-material layers 12 and 22. The sulfide-solid-electrolyte layer 40 includes a sulfur-added layer 43 in an intermediate portion in the thickness direction of the sulfide-solid-electrolyte layer 40. The sulfur-added layer 43 has a higher content of elemental sulfur than any other portion of the sulfide-solid-electrolyte layer 40. The sulfur-added layer 43 substantially does not have any pin holes. The sulfur-added layer 43 is formed by laminating a positive-electrode body 1 and a negative-electrode body 2 that are individually prepared and subjecting the electrode bodies 1 and 2 to a heat treatment so that a positive-electrode-side sulfur-added layer 14 of the positive-electrode body 1 and a negative-electrode-side sulfur-added layer 24 of the negative-electrode body 2 are softened and integrated.

### TECHNICAL FIELD

The present invention relates to a nonaqueous-electrolyte battery produced by individually preparing a positive-electrode body including a positive-electrode active-material layer and a negative-electrode body including a negative-electrode active-material layer, and laminating the electrode bodies in a subsequent step; and a method for producing the nonaqueous-electrolyte battery.

### BACKGROUND ART

Nonaqueous-electrolyte batteries including a positive-electrode layer, a negative-electrode layer, and an electrolyte layer disposed between the electrode layers have been used as power supplies of electric devices that are intended to be repeatedly charged and discharged. The electrode layers of such a battery include a collector having a current-collecting function and an active-material layer containing an active material. Among such nonaqueous-electrolyte batteries, in particular, Li-ion batteries, which are charged and discharged through migration of Li ions between the positive- and negative-electrode layers, have a high discharge capacity in spite of the small size.

An example of the technique of producing such a Li-ion battery is described in Patent Literature 1. In Patent Literature 1, to produce a Li-ion battery, a positive-electrode body having a positive-electrode active-material layer and a negative-electrode body having a negative-electrode active-material layer are individually prepared. A solid-electrolyte layer is formed on at least one of the positive-electrode body and the negative-electrode body. Lamination of the positive-electrode body and the negative-electrode body allows production of a Li-ion battery in a short period of time. In this lamination, in Patent Literature 1, pin holes formed in the solid-electrolyte layer are filled with an ionic liquid containing a Li-containing salt and having a high Li-ion conductivity to thereby suppress short circuits between the positive- and negative-electrode layers.

The main cause for the short circuits lies in that needle-shaped Li crystals (dendrites) generated on the surface of the negative-electrode active-material layer during charge of the Li-ion battery grow through repeated charge and discharge of the Li-ion battery and reach the positive-electrode active-material layer. In particular, the dendrites tend to be generated on surface portions of the negative-electrode active-material layer that are exposed in pin holes formed in the solid-electrolyte layer. The dendrites grow along the inner wall surfaces of the pin holes. To address this situation, Patent Literature 1 employs a liquid that has a high Li-ion conductivity and is inserted into the pin holes to promote elimination of the dendrites during discharge of the Li-ion battery, so that the short circuits are suppressed.

### CITATION LIST

### Patent Literature

PTL 1: Japanese Unexamined Patent Application Publication No. 2008-171588

### SUMMARY OF INVENTION

### Technical Problem

However, the inventors of the present invention performed studies and have found that the Li-ion battery in PTL 1 can be further improved.

Since the liquid in pin holes has a high Li-ion conductivity, dendrites inherently tend to be generated in the pin holes. Accordingly, for example, when charge is repeated before discharge is sufficiently performed, dendrites having grown are not completely eliminated by discharge and new dendrites are generated on the basis of the remaining dendrites, increasing the probability of the occurrence of short circuits.

The present invention has been accomplished under the above-described circumstances. An object of the present invention is to provide a nonaqueous-electrolyte battery that is produced by lamination of individually prepared electrode bodies and that allows suppression of short circuits between the positive- and negative-electrode layers with more certainty; and a method for producing the nonaqueous-electrolyte battery.

### Solution to Problem

(1) A nonaqueous-electrolyte battery according to the present invention includes a positive-electrode active-material layer, a negative-electrode active-material layer, and a sulfide-solid-electrolyte layer disposed between the active-material layers. The sulfide-solid-electrolyte layer in the nonaqueous-electrolyte battery includes a sulfur-added layer in an intermediate portion in the thickness direction of the sulfide-solid-electrolyte layer. The sulfur-added layer has a higher content of elemental sulfur, which is not in the form of a compound, than any other portion of the sulfide-solid-electrolyte layer. The sulfur-added layer substantially does not have any pin holes. When the solid electrolyte is, for example, Li₂S—P₂S₅—P₂O₅, the sulfur-added layer is composed of Li₂S—P₂S₅—P₂O₅ and S.

Since the above-described nonaqueous-electrolyte battery according to the present invention includes the sulfur-added layer that substantially does not have any pin holes, it has no pin holes that continuously extend from the negative-electrode active-material layer to the positive-electrode active-material layer. Accordingly, in a nonaqueous-electrolyte battery according to the present invention, short circuits caused during charge and discharge of the battery substantially do not occur. A nonaqueous-electrolyte battery according to the present invention including the sulfur-added layer that substantially does not have any pin holes can be produced by laminating a positive-electrode body and a negative-electrode body that are individually prepared as described below in a method for producing a nonaqueous-electrolyte battery according to the present invention. Specifically, adhesive layers of a solid electrolyte containing elemental sulfur are formed in the positive-electrode body and the negative-electrode body. When the positive-electrode body and the negative-electrode body are laminated, the adhesive layers of the electrode bodies are bonded together to form the sulfur-added layer in the nonaqueous-electrolyte battery.
(2) In a nonaqueous-electrolyte battery according to an embodiment of the present invention, the content of elemental sulfur of the sulfur-added layer is preferably 1% to 20% of the total number of moles of a solid electrolyte of the sulfur-added layer. When the solid electrolyte is, for example, aLi₂S-bP₂S₅-cP₂O₅ (a, b, and c represent the number of moles of the components), the amount of Li is 2a moles, the amount of P is 2b+2c moles, the amount of O is 5c moles, and the amount of S is a+5b moles. The sum of these amounts, that is, the total number of moles of the solid electrolyte is 3a+7b+7c moles. In this case, the content X in the sulfur-added layer as defined above is 0.01×(3a+7b+7c) to 0.2×(3a+7b+7c). Here, S of the solid electrolyte has a valence of −2 and forms the compounds and hence is different from elemental sulfur having a valence of 0.

When the content of the sulfur in the sulfur-added layer is in the above-described range, the presence of the sulfur-added layer does not result in a considerable decrease in the Li-ion conductivity of the sulfide-solid-electrolyte layer.
(3) In a nonaqueous-electrolyte battery according to an embodiment of the present invention, the content of elemental sulfur of the sulfur-added layer is preferably 1% to 5% of the total number of moles of the solid electrolyte of the sulfur-added layer.

As has been described, the sulfur-added layer of a nonaqueous-electrolyte battery according to the present invention is formed by bonding between adhesive layers formed in the positive-electrode body and the negative-electrode body that are individually prepared. The higher the content of elemental sulfur in the adhesive layers, the higher the adhesion between the adhesive layers becomes. On the other hand, the higher the content of elemental sulfur in the adhesive layers, the lower the proportion of the solid electrolyte in the adhesive layers becomes; thus, the Li-ion conductivity of the adhesive layers tends to decrease. In view of such respects, when the content in the sulfur-added layer of a completed nonaqueous-electrolyte battery is in the range described in (3) above, the battery can be regarded as being produced such that the positive-electrode body and the negative-electrode body are strongly bonded together in the battery production; and, in the battery, a decrease in the Li-ion conductivity of the solid-electrolyte layer caused by elemental sulfur is suppressed.
(4) In a nonaqueous-electrolyte battery according to an embodiment of the present invention, the sulfur-added layer preferably has a thickness of 0.5 to 1 μm.

The Li-ion conductivity of the sulfur-added layer to which elemental sulfur has been added is lower than that of a portion that does not contain elemental sulfur. Accordingly, in view of the performance of the nonaqueous-electrolyte battery, the sulfur-added layer is preferably formed so as to have a small thickness.
(5) A method for producing a nonaqueous-electrolyte battery according to the present invention is a method for producing a nonaqueous-electrolyte battery including a positive-electrode active-material layer, a negative-electrode active-material layer, and a sulfide-solid-electrolyte layer disposed between the active-material layers. The method includes the following steps:

a step of preparing a positive-electrode body including a positive-electrode active-material layer, a positive-electrode-side solid-electrolyte layer, and a positive-electrode-side sulfur-added layer composed of a solid electrolyte that has a higher content of elemental sulfur, which is not in the form of a compound, than the positive-electrode-side solid-electrolyte layer;

a step of preparing a negative-electrode body including a negative-electrode active-material layer, a negative-electrode-side solid-electrolyte layer, and a negative-electrode-side sulfur-added layer composed of a solid electrolyte that has a higher content of elemental sulfur, which is not in the form of a compound, than the negative-electrode-side solid-electrolyte layer; and

a step of laminating the positive-electrode body and the negative-electrode body such that the sulfur-added layers of the electrode bodies are in contact with each other and subjecting the electrode bodies to a heat treatment to bond the sulfur-added layers together.

When the above-described production method according to the present invention is employed, formation of pin holes that continuously extend from the negative-electrode active-material layer to the positive-electrode active-material layer can be suppressed. This is because, positions of pin holes in the positive-electrode body and the negative-electrode body that are individually prepared substantially do not match between the electrode bodies. In addition, in the lamination of the positive-electrode body and the negative-electrode body, a heat treatment is performed so that the sulfur-added layers of the electrode bodies (corresponding to the above-described adhesive layers for bonding the electrode bodies) are softened to be integrated. Thus, pin holes in the sulfur-added layers are substantially eliminated.

When a production method according to the present invention is employed, variations in the Li-ion conductivity in the planar direction of the sulfide-solid-electrolyte layer of the resultant battery can be suppressed. Lamination of a positive-electrode body and a negative-electrode body that are individually prepared naturally results in the formation of gaps therebetween in which the electrode bodies are not in contact with each other. According to the technique of PTL 1, since an ionic liquid is inserted into the gaps, a considerable decrease in the Li-ion conductivity at the positions of the gaps is not caused. However, since a Li-ion conductivity due to direct contact between the electrode layers is different from a Li-ion conductivity in the presence of the ionic liquid between the electrode layers, variations in the Li-ion conductivity in the bonded surfaces of the electrode bodies tend to be caused. Thus, the performance of the battery is not stable. In contrast, in a production method according to the present invention, the sulfur-added layers of the electrode bodies that are individually prepared are softened to be bonded together. Thus, variations in the Li-ion conductivity in the planar direction of the battery are not substantially caused.
(6) In a method for producing a nonaqueous-electrolyte battery according to an embodiment of the present invention, the heat treatment is preferably performed at 80° C. to 200° C. for 1 to 20 h, more preferably at 110° C. to 200° C. for 1 to 20 h.

When the heat treatment is performed under such conditions, the sulfur-added layers of the electrode layers can be strongly bonded together without thermally degrading components of the battery. When the heat-treatment temperature exceeds 200° C., crystallization of the solid-electrolyte layer proceeds and cracking may be caused in the solid-electrolyte layer.
(7) In a method for producing a nonaqueous-electrolyte battery according to an embodiment of the present invention, the heat treatment is preferably performed at 170° C. to 200° C. for 1 to 20 h.

When the content of elemental sulfur in the sulfur-added layers of the electrode bodies is low and the heat-treatment temperature is low, fusion between the sulfur-added layers may become insufficient. In contrast, when the heat-treatment temperature is made 170° C. or more, the sulfur-added layers can be strongly bonded together.
(8) In a method for producing a nonaqueous-electrolyte battery according to an embodiment of the present invention, the positive-electrode body and the negative-electrode body are preferably bonded together under a pressure during the heat treatment.

The application of a pressure during the heat treatment increases the strength of the bonding between sulfur-added layers of the electrode bodies.
(9) In a method for producing a nonaqueous-electrolyte battery according to an embodiment of the present invention, the pressure during the heat treatment is preferably 10 to 200 MPa.

When the content of elemental sulfur in the sulfur-added layers of the electrode bodies is low and the pressure during the heat treatment is low, fusion between the sulfur-added layers may become insufficient. In contrast, when the pressure during the heat treatment is 10 to 200 MPa, the sulfur-added layers can be strongly fused together. When the pressure exceeds 200 MPa, cracking may be caused in the configurations of the electrode layers.

### Advantageous Effects of Invention

In a nonaqueous-electrolyte battery according to the present invention, short circuits caused by dendrites generated during charge of the battery can be effectively suppressed.

### BRIEF DESCRIPTION OF DRAWINGS

FIG. 1A is a longitudinal sectional view of a nonaqueous-electrolyte battery described in a first embodiment.

FIG. 1B is a longitudinal sectional view of the battery illustrated in FIG. 1A before assembly.

### DESCRIPTION OF EMBODIMENTS

### First Embodiment

### <<Overall Configuration of Li-Ion Battery>>

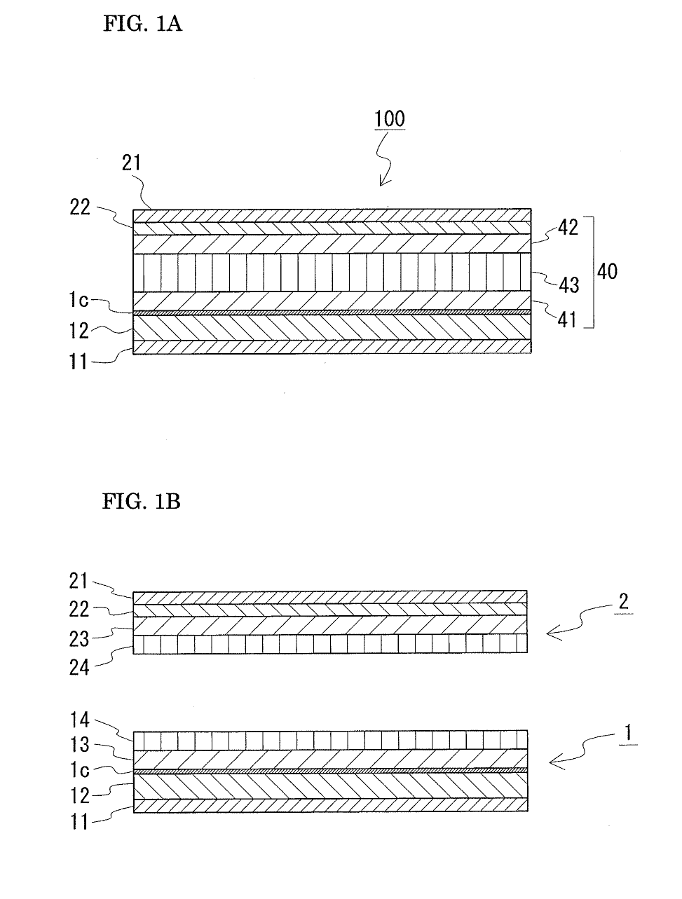

A Li-ion battery (nonaqueous-electrolyte battery) 100 illustrated in FIG. 1A includes a positive-electrode collector 11, a positive-electrode active-material layer 12, an intermediate layer 1c, a sulfide-solid-electrolyte layer 40, a negative-electrode active-material layer 22, and a negative-electrode collector 21. Novel features of the battery 100 are that the sulfide-solid-electrolyte layer 40 of the battery 100 is divided, with respect to the content of elemental sulfur, into three parts: a positive-electrode-side solid-electrolyte layer 41, a negative-electrode-side solid-electrolyte layer 42, and a sulfur-added layer 43 sandwiched between the layers 41 and 42; and that the content of elemental sulfur in the sulfur-added layer 43 is higher than the content of elemental sulfur in the other layers 41 and 42.

The Li-ion battery 100 can be produced by a method for producing a nonaqueous-electrolyte battery according to the present invention including the following steps, that is, by lamination of a positive-electrode body 1 and a negative-electrode body 2 that are individually prepared as illustrated in FIG. 1B.
(A) Prepare the positive-electrode body 1.
(B) Prepare the negative-electrode body 2.
(C) Laminate the positive-electrode body 1 and the negative-electrode body 2 and subject the electrode bodies 1 and 2 to a heat treatment.

Note that the order of the steps A and B can be inverted.

### <<Step A: Preparation of Positive-Electrode Body>>

The positive-electrode body 1 includes, on the positive-electrode collector 11, the positive-electrode active-material layer 12, a positive-electrode-side solid-electrolyte layer (PSE layer) 13, and a positive-electrode-side sulfur-added layer (PA layer) 14. To prepare the positive-electrode body 1, a substrate that is to serve as the positive-electrode collector 11 is first prepared and the remaining layers 12, 13, and 14 are then sequentially formed on the substrate. As illustrated in the drawing, the intermediate layer 1c is preferably formed between the positive-electrode active-material layer 12 and the PSE layer 13. As described below, the intermediate layer 1c is used to suppress an increase in the resistance between the positive-electrode active-material layer 12 and the PSE layer 13.

### [Positive-Electrode Collector]

The substrate that is to serve as the positive-electrode collector 11 may be composed of a conductive material only or may be constituted by an insulating substrate having a conductive-material film thereon. In the latter case, the conductive-material film functions as a collector. The conductive material is preferably any one selected from Al, Ni, alloys of the foregoing, and stainless steel.

### [Positive-Electrode Active-Material Layer]

The positive-electrode active-material layer 12 contains a positive-electrode active material that mainly causes the battery reactions. The positive-electrode active material may be a substance having a layered rock-salt crystal structure, for example, a substance represented by Liα_{X}β_{(1-X)}O₂ (α represents any one selected from Co, Ni, and Mn; β represents any one selected from Fe, Al, Ti, Cr, Zn, Mo, and Bi; X is 0.5 or more). Specific examples of the positive-electrode active material include LiCoO₂, LiNiO₂, LiMnO₂, LiCo_{0.5}Fe_{0.5}O₂, and LiCo_{0.5}Al_{0.5}O₂. In addition, the positive-electrode active material may be a substance having a spinel crystal structure (for example, LiMn₂O₄) or a substance having an olivine crystal structure (for example, Li_{X}FePO₄ (0<X<1)). The positive-electrode active-material layer 12 may contain a conductive aid and a binder.

The positive-electrode active-material layer 12 may be formed by a wet process or a dry process. Examples of the wet process include a sol-gel process, a colloid process, and a casting process. Examples of the dry process include vapor-phase processes such as a vacuum deposition process, an ion plating process, a sputtering process, and a laser ablation process.

### [Positive-Electrode-Side Solid-Electrolyte Layer]

The positive-electrode-side solid-electrolyte layer (PSE layer) 13 is a Li-ion conductor containing a sulfide. The PSE layer 13 is to serve as the positive-electrode-side solid-electrolyte layer 41 in the completed battery 100 illustrated in FIG. 1A. Characteristics required for the PSE layer 13 are a high Li-ion conductivity and a low electron conductivity. Specifically, the PSE layer 13 preferably has a Li-ion conductivity (20° C.) of 10⁻⁵ S/cm or more, in particular, 10⁻⁴ S/cm or more. The PSE layer 13 preferably has an electron conductivity of 10⁻⁸ S/cm or less. The material of the PSE layer 13 may be, for example, Li₂S—P₂S₅—P₂O₅ (Li-ion conductivity: 1×10⁻⁴ to 3×10⁻³ S/cm). The sulfur content in this PSE layer 13 corresponds to the composition ratios. It is considered that the sulfur in the PSE layer 13 is a sulfur having a valence of −2 and the PSE layer 13 does not substantially contain elemental sulfur having a valence of 0.

The PSE layer 13 may be formed by a vapor-phase process. Examples of the vapor-phase process include a vacuum deposition process, a sputtering process, an ion plating process, and a laser ablation process.

### [Intermediate Layer]

When the PSE layer 13 contains a sulfide solid electrolyte, this sulfide solid electrolyte reacts with a positive-electrode active material that is an oxide and contained in the positive-electrode active-material layer 12 adjacent to the PSE layer 13. As a result, the resistance of the near-interface region between the positive-electrode active-material layer 12 and the PSE layer 13 increases and the discharge capacity of the Li-ion battery 100 decreases. In contrast, formation of the intermediate layer 1c allows suppression of the increase in the resistance and the decrease in the discharge capacity of the battery 100, the decrease being caused during charge and discharge.

A material for the intermediate layer 1c may be an amorphous Li-ion-conductive oxide such as LiNbO₃ or LiTaO₃. In particular, LiNbO₃ allows effective suppression of an increase in the resistance of the near-interface region between the positive-electrode active-material layer 12 and the PSE layer 13.

### [Positive-Electrode-Side Sulfur-Added Layer]

The positive-electrode-side sulfur-added layer (PA layer) 14 is to serve as a portion of the sulfide-solid-electrolyte layer 40 of the battery 100 (specifically, a portion of the sulfur-added layer 43 in FIG. 1A) when the battery 100 is completed by lamination of the positive-electrode body 1 and the negative-electrode body 2 in the step C described below. The PA layer 14 also serves as an adhesive at the time of lamination of the electrode bodies 1 and 2.

Since the PA layer 14 is to serve as a portion of the sulfide-solid-electrolyte layer 40 of the completed battery 100, it is mainly composed of a sulfide-based solid electrolyte. The PA layer 14 further contains elemental sulfur (zero-valent sulfur, which is not in the form of a compound). The PA layer 14 is made to contain elemental sulfur so that elemental sulfur (melting point: about 113° C.) in the PA layer 14 functions as an adhesive at the time of lamination of the electrode bodies 1 and 2 by a heat treatment in the step C described below. In addition, elemental sulfur is less likely to react with the sulfide solid electrolyte and does not cause a decrease in the Li-ion conductivity of the solid electrolyte. Accordingly, when the PA layer 14 serves as a portion of the solid-electrolyte layer of the battery, it does not degrade the function of the solid-electrolyte layer. However, the proportion of the solid electrolyte in the PA layer 14 decreases because of the amount of elemental sulfur. Accordingly, the PA layer 14 has a lower Li-ion conductivity than the PSE layer 13.

The PA layer 14 has a higher content of elemental sulfur than the PSE layer 13. For example, the content of elemental sulfur in the PA layer 14 is preferably 1% to 20% of the total number of moles of the solid electrolyte in the PA layer 14. For example, when the total number of moles of the solid electrolyte in the PA layer 14 is 100, the PA layer 14 further contains 1 to 20 moles of elemental sulfur. Here, an excessively large amount of elemental sulfur added to the PA layer 14 may result in a decrease in the Li-ion conductivity of the PA layer 14. The content of elemental sulfur is more preferably 1% to 5% of the total number of moles of the solid electrolyte.

When the PA layer 14 has an average thickness of 0.05 μm or more, it sufficiently functions as an adhesive at the time of lamination of the electrode bodies 1 and 2. Here, since the PA layer 14 has a slightly lower Li-ion conductivity than the PSE layer 13, the PA layer 14 preferably does not have an excessively large thickness. Accordingly, the upper limit of the thickness of the PA layer 14 is preferably 10 μm. More preferably, the upper limit of the thickness of the PA layer 14 is 0.5 μm.

The PA layer 14 can be formed by a vapor-phase process. For example, an evaporation source (for example, Li₂S—P₂S₅—P₂O₅) prepared for the formation of the PSE layer 13 and an evaporation source of sulfur powder are placed in the same deposition boat or different deposition boats, and the evaporation sources are evaporated to form the PA layer 14.

### <<Step B: Preparation of Negative-Electrode Body>>

The negative-electrode body 2 includes, on the negative-electrode collector 21, the negative-electrode active-material layer 22, a negative-electrode-side solid-electrolyte layer (NSE layer) 23, and a negative-electrode-side sulfur-added layer (NA layer) 24. To prepare the negative-electrode body 2, a substrate that is to serve as the negative-electrode collector 21 is prepared and the remaining layers 22, 23, and 24 are then sequentially formed on the substrate.

### [Negative-Electrode Collector]

The substrate that is to serve as the negative-electrode collector 21 may be composed of a conductive material only or may be constituted by an insulating substrate having a conductive-material film thereon. In the latter case, the conductive-material film functions as a collector. For example, the conductive material is preferably any one selected from Cu, Ni, Fe, Cr, and alloys of the foregoing.

### [Negative-Electrode Active-Material Layer]

The negative-electrode active-material layer 22 contains a negative-electrode active material that mainly causes the battery reactions. The negative-electrode active material is preferably metallic Li. Here, other than metallic Li, the negative-electrode active material may be, for example, an element (such as Si) that forms an alloy with Li; however, in this case, there is a problem that the discharge capacity becomes much lower than the charge capacity (that is, the problem of generation of irreversible capacity) in the first charge-discharge cycle. In contrast, when the negative-electrode active-material layer 22 is formed of metallic Li, the irreversible capacity is almost eliminated.

The negative-electrode active-material layer 22 is preferably formed by a vapor-phase process. Alternatively, a thin film of metallic Li may be placed on the negative-electrode collector 21 and the resultant structure may be pressed. Alternatively, the negative-electrode active-material layer 22 may be formed on the negative-electrode collector 21 by an electrochemical process.

### [Negative-Electrode-Side Solid-Electrolyte Layer]

The negative-electrode-side solid-electrolyte layer (NSE layer 23) is to serve as a portion of the sulfide-solid-electrolyte layer 40 of the battery 100 (the negative-electrode-side solid-electrolyte layer 42 in FIG. 1A) when the battery 100 is completed. As with the PSE layer 13, the NSE layer 23 is required to have a high Li conductivity and a low electron conductivity. As in the PSE layer 13, the material of the NSE layer 23 is preferably Li₂S—P₂S₅—P₂O₅ or the like. The sulfur content in this NSE layer 23 corresponds to the composition ratios.

### [Negative-Electrode-Side Sulfur-Added Layer]

The negative-electrode-side sulfur-added layer (NA layer) 24 is formed for the same purpose as in the PA layer 14. The NA layer 24 plays the same role as the PA layer 14, that is, serves as an adhesive at the time of lamination of the electrode bodies 1 and 2. The NA layer 24 functions as a portion of the solid-electrolyte layer of the resultant battery 100 (a portion of the sulfur-added layer 43 in FIG. 1A). Accordingly, the NA layer 24 may be formed so as to have the same composition, thickness, and content of elemental sulfur as the PA layer 14 (alternatively, the NA layer 24 may be formed so as to be different from the PA layer 14 in the composition, thickness, and content of elemental sulfur). The NA layer 24 may be formed in the same manner as in the PA layer 14.

### <<Step C: Lamination of Positive-Electrode Body and Negative-Electrode Body, and Heat Treatment>>

The positive-electrode body 1 and the negative-electrode body 2 are then laminated such that the PA layer 14 and the NA layer 24 face each other to produce the Li-ion battery 100. At this time, a heat treatment is performed so that the PA layer 14 and the NA layer 24 are softened and integrated. Thus, the sulfur-added layer 43 is formed.

The heat-treatment conditions in the step C are selected such that the PA layer 14 and the NA layer 24 are softened without being degraded. Specifically, the heat treatment is preferably performed in an inert-gas atmosphere at a heat-treatment temperature of 80° C. to 200° C. for a heat-treatment time of 1 to 20 h. The heat-treatment temperature and time are optimally selected in accordance with the content of elemental sulfur in the PA layer 14 and the NA layer 24. When the content of elemental sulfur (the definition is described above) in the PA layer 14 and the NA layer 24 is low, for example, 5% or less, employment of a relatively high heat-treatment temperature allows fusion between the PA layer 14 and the NA layer 24 with certainty. For example, the heat-treatment temperature is preferably 110° C. or more, more preferably 170° C. or more.

In the step C, pressure may be applied during the heat treatment. When the content of elemental sulfur in the PA layer 14 and the NA layer 24 is low, for example, 5% or less, a heat treatment without application of pressure may result in insufficient fusion between the PA layer 14 and the NA layer 24. When a pressure of 10 to 200 MPa is applied during the heat treatment, fusion between the PA layer 14 and the NA layer 24 can be achieved with more certainty.

As a result of performing the step C, the Li-ion battery 100 including the sulfide-solid-electrolyte layer 40 is formed. Here, when the PA layer 14 and the NA layer 24 are integrated, excessive elemental sulfur contained in the layers 14 and 24 softens to close pin holes formed in the layers 14 and 24. Thus, the sulfur-added layer 43 substantially has no pin holes. As a result, the produced battery 100 has no pin holes that continuously extend from the negative-electrode active-material layer 22 to the positive-electrode active-material layer 12. Thus, repeated charge and discharge of the battery 100 substantially does not cause short circuits.

Here, the average thickness of the sulfur-added layer 43 formed by fusion between the PA layer 14 and the NA layer 24 may be regarded as being equal to the total thickness of the PA layer 14 and the NA layer 24 that are to be fused.

### EXAMPLE 1

The Li-ion battery 100 according to the first embodiment described with reference to FIG. 1 was produced and the cycle characteristic thereof was evaluated. As COMPARATIVE EXAMPLE, a Li-ion battery in which all the layers other than collectors in the battery were formed by a vapor-phase process was produced and the cycle characteristic thereof was also evaluated.

### <Li-ion Battery of Example>

To produce the Li-ion battery 100, the positive-electrode body 1 and the negative-electrode body 2 having the following configurations were prepared.

### <<Positive-Electrode Body 1>>

positive-electrode collector 11 stainless-steel foil having a thickness of 10 μm
positive-electrode active-material layer 12 LiCoO₂ film having a thickness of 5 μm: the film was formed by a laser ablation process and subsequently annealed at 500° C.
intermediate layer 1c LiNbO₃ film having a thickness of 20 nm: RF sputtering process
PSE layer 13 Li₂S—P₂S₅—P₂O₅ film having a thickness of 5 μm (content of elemental sulfur in the film was 0 mol %): laser ablation process
PA layer 14 Li₂S—P₂S₅—P₂O₅—S film having a thickness of 5 μm (content of elemental sulfur in the film was 20 mol %): laser ablation process

### <<Negative-Electrode Body 2>>

negative-electrode collector 21 stainless-steel foil having a thickness of 10 μm
negative-electrode active-material layer 22 metallic Li film having a thickness of 1 μm: vacuum deposition process
NSE layer 23 Li₂S—P₂S₅—P₂O₅ film having a thickness of 5 μm (content of elemental sulfur in the film was 0 mol %): laser ablation process
NA 24 Li₂S—P₂S₅—P₂O₅—S film having a thickness of 5 μm (content of elemental sulfur in the film was 20 mol %): laser ablation process

The positive-electrode body 1 and the negative-electrode body 2 prepared were then laminated such that the sulfur-added layers 14 and 24 were in contact with each other. While the electrode bodies 1 and 2 were pressed together, they were subjected to a heat treatment. The load of the pressing was 10 kgf/cm²(≈0.98 MPa). The heating was performed in an inert-gas atmosphere at 130° C. for 5 h. As a result of the heat treatment, the sulfur-added layers 14 and 24 melt at the contact interface therebetween to form the integrated sulfur-added layer 43 illustrated in FIG. 1A.

The thus-produced Li-ion battery 100 was contained in a coin cell and subjected to a charge-discharge test. The test conditions were a cutoff voltage of 3.0 V to 4.2 V and a current density of 0.05 mA/cm². As a result, the discharge capacity that was 70% or more of the initial capacity (discharge capacity of the first cycle) was maintained for 120 cycles.

### <Li-ion Battery of Comparative Example>

Unlike EXAMPLE 1, a positive-electrode body and a negative-electrode body that had no sulfur-added layers were prepared and these electrode bodies were laminated to produce a Li-ion battery.

This Li-ion battery was also subjected to a charge-discharge cycle test under the same conditions as in the Li-ion battery of EXAMPLE. As a result, the discharge capacity that was 70% or more of the initial capacity was maintained for 30 cycles.

### EXAMPLE 2

In EXAMPLE 2, nonaqueous-electrolyte batteries (samples A to F) were produced in which the content of elemental sulfur and the heat-treatment conditions were varied. The materials for producing the samples A to F and the method for producing the samples A to F were almost the same as in EXAMPLE 1 described above, but were different from EXAMPLE 1 in the thickness and the content of elemental sulfur of the PA layer 14 and the NA layer 24 in the electrode bodies 1 and 2, and the heat-treatment conditions for fusion between the electrode bodies 1 and 2. The differences of the production of the samples A to F from EXAMPLE 1 are described in Table I below. Note that the thickness of the sulfur-added layer 43 in the Table was the total thickness of the PA layer 14 and the NA layer 24, and the thicknesses of the layers 14 and 24 were the same. The sulfur content (%) of the sulfur-added layer 43 in the Table was equal to the sulfur content (%) of the PA layer 14 and the sulfur content (%) of the NA layer 24. The heat-treatment conditions were heating at 200° C. for 1 h under a pressing load of 50 MPa.

The thus-produced samples A to F were subjected to a cycle test in which charge and discharge were performed at a cutoff voltage of 3.0 V to 4.2 V and a current density of 0.5 mA/cm² and the number of cycles over which the discharge capacity that was 70% or more of the initial capacity was maintained was determined. In addition, the total resistance (Ω·cm²) of the samples A to F was determined. The results are also described in Table I.

TABLE I

| | Sulfur (S)-added layer | | Heat-treatment conditions | | | Cycle | Total |
|---|---|---|---|---|---|---|---|
| | S content | Thickness | Temperature | Time | Pressure | characteristic | resistance |
| Sample | (%) | (μm) | (° C.) | (h) | (MPa) | *1 | (Ω · cm²) |
| A | 1 | 0.5 | 200 | 1 | 50 | 150 | 45 |
| B | 0.5 | 0.5 | 200 | 1 | 50 | 50 | 41 |
| C | 1 | 0.2 | 200 | 1 | 50 | 70 | 37 |
| D | 5 | 1 | 200 | 1 | 50 | 170 | 46 |
| E | 10 | 1 | 200 | 1 | 50 | 180 | 70 |
| F | 5 | 5 | 200 | 1 | 50 | 200 | 120 |

*1: the number of cycles over which the discharge capacity that was 70% or more of the initial capacity was maintained

From the results in Table I, by making the content of elemental sulfur of the sulfur-added layer 43 be 1 to 5 mol % and making the thickness of the sulfur-added layer 43 be 0.5 to 1.0 μm, the cycle characteristic can be enhanced and the total resistance of the battery can be decreased.

The present invention is not limited by the above-described embodiments at all. That is, the configurations of the nonaqueous-electrolyte batteries described in the above-described embodiments can be properly modified without departing from the spirit and scope of the present invention.

### INDUSTRIAL APPLICABILITY

A nonaqueous-electrolyte battery according to the present invention can be suitably used as power supplies of electric devices that are intended to be repeatedly charged and discharged.

### REFERENCE SIGNS LIST

100 Li-ion battery (nonaqueous-electrolyte battery)
   positive-electrode body
      11 positive-electrode collector
      12 positive-electrode active-material layer
      1c intermediate layer
      13 positive-electrode-side solid-electrolyte layer (PSE layer)
      14 positive-electrode-layer-side sulfur-added layer (PA layer)
   2 negative-electrode body
      21 negative-electrode collector
      22 negative-electrode active-material layer
      23 negative-electrode-side solid-electrolyte layer (NSE layer)
      24 negative-electrode-layer-side sulfur-added layer (NA layer)
   40 sulfide-solid-electrolyte layer
      41 positive-electrode-side solid-electrolyte layer
      42 negative-electrode-side solid-electrolyte layer
      43 sulfur-added layer

1. A nonaqueous-electrolyte battery comprising a positive-electrode active-material layer, a negative-electrode active-material layer, and a sulfide-solid-electrolyte layer disposed between the active-material layers,
wherein the sulfide-solid-electrolyte layer includes a sulfur-added layer in an intermediate portion in a thickness direction of the sulfide-solid-electrolyte layer,
the sulfur-added layer has a higher content of elemental sulfur, which is not in the form of a compound, than any other portion of the sulfide-solid-electrolyte layer, and
the sulfur-added layer substantially does not have any pin holes.

2. The nonaqueous-electrolyte battery according to claim 1, wherein the content of elemental sulfur of the sulfur-added layer is 1% to 20% of the total number of moles of a solid electrolyte of the sulfur-added layer.

3. The nonaqueous-electrolyte battery according to claim 2, wherein the content is 1% to 5% of the total number of moles of the solid electrolyte of the sulfur-added layer.

4. The nonaqueous-electrolyte battery according to claim 1, wherein the sulfur-added layer has an average thickness of 0.5 to 1 μm.

5. A method for producing a nonaqueous-electrolyte battery including a positive-electrode active-material layer, a negative-electrode active-material layer, and a sulfide-solid-electrolyte layer disposed between the active-material layers, the method comprising:
a step of preparing a positive-electrode body including a positive-electrode active-material layer, a positive-electrode-side solid-electrolyte layer, and a positive-electrode-side sulfur-added layer composed of a solid electrolyte that has a higher content of elemental sulfur, which is not in the form of a compound, than the positive-electrode-side solid-electrolyte layer;
a step of preparing a negative-electrode body including a negative-electrode active-material layer, a negative-electrode-side solid-electrolyte layer, and a negative-electrode-side sulfur-added layer composed of a solid electrolyte that has a higher content of elemental sulfur, which is not in the form of a compound, than the negative-electrode-side solid-electrolyte layer; and
a step of laminating the positive-electrode body and the negative-electrode body such that the sulfur-added layers of the electrode bodies are in contact with each other and subjecting the electrode bodies to a heat treatment to bond the sulfur-added layers together.

6. The method for producing a nonaqueous-electrolyte battery according to claim 5, wherein the heat treatment is performed at 80° C. to 200° C. for 1 to 20 h.

7. The method for producing a nonaqueous-electrolyte battery according to claim 5, wherein the heat treatment is performed at 110° C. to 200° C. for 1 to 20 h.

8. The method for producing a nonaqueous-electrolyte battery according to claim 5, wherein the heat treatment is performed at 170° C. to 200° C. for 1 to 20 h.

9. The method for producing a nonaqueous-electrolyte battery according to claim 5, wherein the positive-electrode body and the negative-electrode body are bonded together under a pressure during the heat treatment.

10. The method for producing a nonaqueous-electrolyte battery according to claim 9, wherein the pressure is 10 to 200 MPa.
